(19) United States
(12) Patent Application Publication
(10) Pub. No.: US 2005/0251581 A1
(43) Pub. Date: Nov. 10, 2005

(54) Embedded computer system for data transmission between multiple micro-processors and method thereof

(75) Inventor: Sen-Li Cheng, Taoyuan (TW)

Correspondence Address: Richard P. Berg, Esq.;c/o LADAS & PARRY, 5670 Wilshire Boulevard, Suite 2100, Los Angeles, CA, 90036-5679, US

(73) Assignee: BENQ CORPORATION

(21) Appl. No.: 11/084,436

(22) Filed: Mar. 17, 2005

(30) Foreign Application Priority Data
Mar. 24, 2004 (TW) 093108029

(51) Int. Cl. G06F 15/76

(52) U.S. Cl. 709/236

(57) ABSTRACT

The invention relates to an embedded computer system. The embedded computer system comprises a first micro-processor, a second micro-processor, and a serial data bus. The first micro-processor comprises a first transmission controlling program. The second micro-processor comprises a second transmission controlling program. The serial data bus enables the first micro-processor to transmit a first transmission data to the second micro-processor. The first transmission controlling program of the first micro-processor separates the first transmission data into multiple sections of data messages according to a predetermined data cutting rule, then the data messages are sequentially transmitted to the second micro-processor via the serial data bus. Finally, the second transmission controlling program of the second micro-processor reconstructs the received data messages to form the first transmission data according to a corresponding data reconstruction rule.

### BACKGROUND OF THE INVENTION

1. Field of the Invention

The present invention relates to an embedded computer system that comprises several micro-processors; each micro-processor of the embedded computer system is able to exchange data at the same time via the serial data bus.

2. Description of the Prior Art

With the development of computer science, embedded computer systems with multiple functional modules are extensively used. In conventional embedded computer systems, each functional module has a micro-processor for controlling each functional module to perform the predetermined function, and each micro-processor is able to transmit and receive data to and from one another.

Generally, in the embedded computer system, the micro-processor supports the serial data transmission method. However, conventional embedded computer system does not adopt the serial data transmission method for performing data transmission between micro-processors. The main reason depends on the following two reasons.

First, conventional embedded computer systems lack the suitable controlling functions to control the data transmission between micro-processors via the serial data bus; thus, the data transmission process might cause data lost or error. Second, when two micro-processors establish a communication function for performing the data exchange via the serial data bus, that communication function occupies the serial data bus, and other micro-processors must wait until the previous data exchange is finished before they are able to perform the data exchange via the serial data bus. The waiting condition affects the overall efficiency of the data transmission of the embedded computer system. This problem becomes worse with more functional modules in the embedded computer system, meaning more micro-processors also.

In consideration of the two above-mentioned reasons, in conventional embedded computer system, data transmission between two micro-processors uses the shared memory method. The first micro-processor stores the data into the shared memory, and then the second micro-processor accesses the data instantaneously or regularly. When the two micro-processors continuously transmit data, if the second micro-processor is unable to instantaneously access data from the shared memory to make room for the memory, the shared memory does not have enough room for storing the incoming data, and the data is unable to be transmitted smoothly. In other words, in conventional data transmission method, the capacity of the shared memory is one limiting factor of the data transmission. However, with the increase of functional modules in the embedded computer system and the increase of complexity of the processed data of each micro-processor, the need of more capacity of the shared memory becomes higher, and the cost of the embedded computer system becomes higher also.

### SUMMARY OF THE INVENTION

The objective of the present invention is to provide an embedded computer system that comprises several micro-processors; each micro-processor of the embedded computer system is able to exchange data via the serial data bus.

Another objective of the present invention is to provide a data transmission method for the embedded computer system; the data transmission method controls each micro-processor of the embedded computer system to exchange data via the serial data bus.

The embedded computer system of the present invention comprises a first micro-processor, a second micro-processor, and a serial data bus. The first micro-processor comprises a first transmission controlling program. The second micro-processor comprises a second transmission controlling program. The serial data bus enables the first micro-processor to transmit a first transmission data to the second micro-processor. The first transmission controlling program of the first micro-processor separates the first transmission data into multiple sections of data messages according to a predetermined data cutting rule, and the data messages are then sequentially transmitted to the second micro-processor via the serial data bus. Then, the second transmission controlling program of the second micro-processor reconstructs the received data messages to form the first transmission data according to a corresponding data reconstruction rule.

In the embedded computer system of the present invention, the embedded computer system separates the transmission data into multiple sections of data messages by the first transmission controlling program according to the data cutting rule, and then reconstructs the received multiple sections of data messages to form the original transmission data by the second transmission controlling program according to the corresponding data reconstruction rule. Therefore, when each micro-processor of the embedded computer system of the present invention is able to exchange data via the serial data bus, the accuracy of the data is still being maintained. Besides, by separateting the transmission data into multiple sections of data messages, during the intervals between the transmissions of different sections of data messages, the serial data bus is idle; thus, different micro-processors are able to transmit data via the serial data bus, so that the waiting time can be reduced.

The advantage and spirit of the invention may be understood by the following recitations together with the appended drawings.

### BRIEF DESCRIPTION OF THE APPENDED DRAWINGS

FIG. 1 is a block diagram of the embedded computer system of the present invention.

FIG. 2 is a schematic diagram of the data cutting method of the present invention.

FIG. 3 is a schematic diagram of the hardware framework of the present invention.

FIG. 4 is a schematic diagram of the transmission pre-processing method of the present invention.

FIG. 5 is a schematic diagram of the transmission post-processing method of the present invention.

FIG. 6 is a flow chart of the data transmission method of the embedded computer system of the present invention.

FIG. 7 is a flow chart of the data transmission method of the present invention.

### DETAILED DESCRIPTION OF THE INVENTION

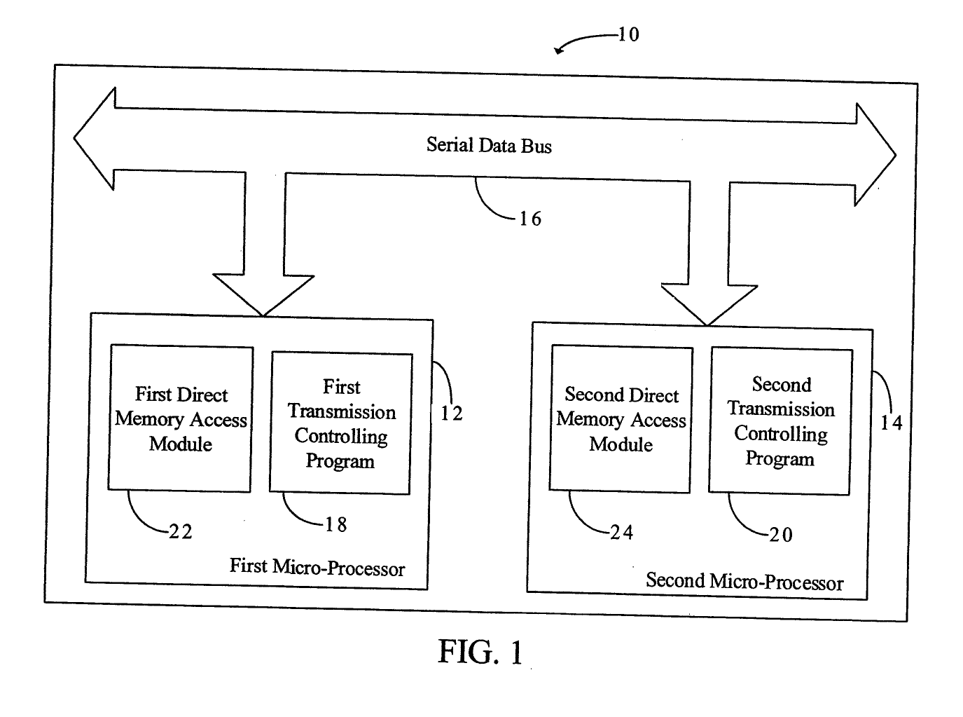

Referring to FIG. 1, FIG. 1 is a block diagram of the embedded computer system 10 of the present invention. The embedded computer system of the present invention comprises a plurality of micro-processors. The embedded computer system of the present invention can be applied as a non-PC embedded computer system, so as to make each micro-processor transmits data via the serial data bus.

In one embodiment, the embedded computer system 10 of the present invention comprises a first micro-processor 12, a second micro-processor 14, and a serial data bus 16. The first micro-processor 12 and the second micro-processor 14 both connect with the serial data bus 16 and are able to transmit data via the serial data bus 16.

The first micro-processor 12 and the second micro-processor 14 respectively comprise a first transmission controlling program 18 and a second transmission controlling program 20. The first transmission controlling program 18 and the second transmission controlling program 20 are the same program module, and they respectively control the data transmitting/receiving action of the first micro-processor 12 and the second micro-processor 14. The first micro-processor 12 and the second micro-processor 14 respectively comprise a first direct memory access module 22 and a second direct memory access module 24.

When the first micro-processor 12 desires to transmit a first transmission data (not shown in FIG. 1) to the second micro-processor 14, the first transmission controlling program 18 separates the first transmission data into multiple sections of data messages according to a predetermined data cutting rule. When the first micro-processor 12 transmits the first transmission data to the second micro-processor 14, the first micro-processor 12 transmits the multiple sections of data messages to the second micro-processor by the first direct memory access module 22. The multiple sections of data messages are sequentially transmitted to the second micro-processor 14 via the serial data bus 16. Then, the second transmission controlling program 20 of the second micro-processor 14 reconstructs the received data messages to form the first transmission data according to a corresponding data reconstruction rule.

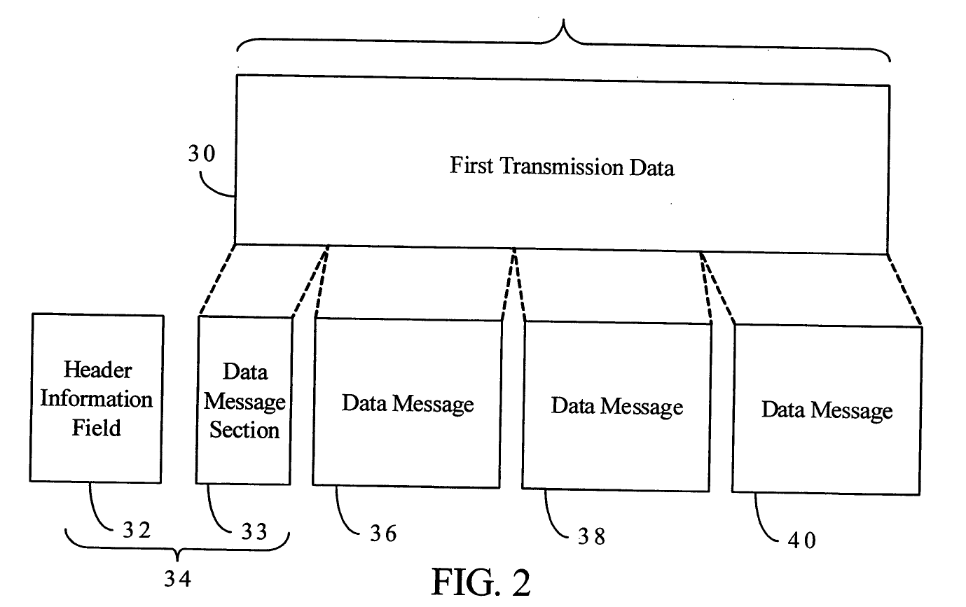

Referring to FIG. 2, FIG. 2 is a schematic diagram of separating the first transmission data 30 according to the data cutting rule of the embedded computer system 10 shown in FIG. 1. The process of the first transmission controlling program 18 to separate the first transmission data 30 according to the predetermined data cutting rule is described as follows. First, according to the contents of the first transmission data 30, the present invention generates a header information field 32. The header information field 32 is used for recording the data length information and the data type information of the first transmission data 30. The data length information records the total capacity units of the first transmission data 30, and the data type information records the file format of the first transmission data 30.

Then, the first transmission data 30 is sequentially separated into several data messages (33, 36, 38, and 40). In these data messages which are sequentially separated, the first data message 33 and the header information field 32 combine as one section of data message and are regarded as the head data message 34. The following data messages (36, 38, and 40) only comprise the data messages from the first transmission data 30, and the three data messages (36, 38, and 40) are three data fields with equal length data messages. The data length of the head data message 34 and the other following data messages (36, 38, and 40) are all the same.

After the first transmission controlling program 18 of the first micro-processor 12 separates the first transmission data 30, the first transmission controlling program 18 uses the first direct memory access module 22 to sequentially transmit the multiple sections of data messages to the second micro-processor 14 via the serial data bus 16. When each section of data messages (34, 36, 38, and 40) is sequentially transmitted to the second micro-processor 14, the second transmission controlling program 20 first obtains the number of sections of the present transmitted data message from the data recorded in the header information field 32 of the head data message 34. Because the header information field 32 records the data length information of the first transmission data, and the length of each cut section of data messages are the same, after the second transmission controlling program 20 receives the head data message 34, the total number of sections of the data messages needed to be transmitted can be obtained. The second transmission controlling program 20 also counts the number of sections of the received data messages and determines whether the transmission has been completed.

The embedded computer system 10 of the present invention shown in FIG. 1 is also able to transmit the transmission data from the second micro-processor 14 to the first micro-processor 12. Because the first transmission controlling program 18 and the second transmission controlling program 20 are the same program module, the second transmission controlling program 20 is able to perform the above-mentioned controlling method of the first transmission controlling program 18. In another embodiment, a second transmission data needs to be transmitted from the second micro-processor 14 to the first micro-processor 12; the second transmission controlling program 20 separates the second transmission data into multiple data messages according to the above-mentioned data cutting rule, and then the data messages are sequentially transmitted to the first micro-processor 12 via the serial data bus 16. Then, the first transmission controlling program 18 of the first micro-processor 12 reconstructs the received data messages to form the second transmission data by the corresponding data reconstruction rule.

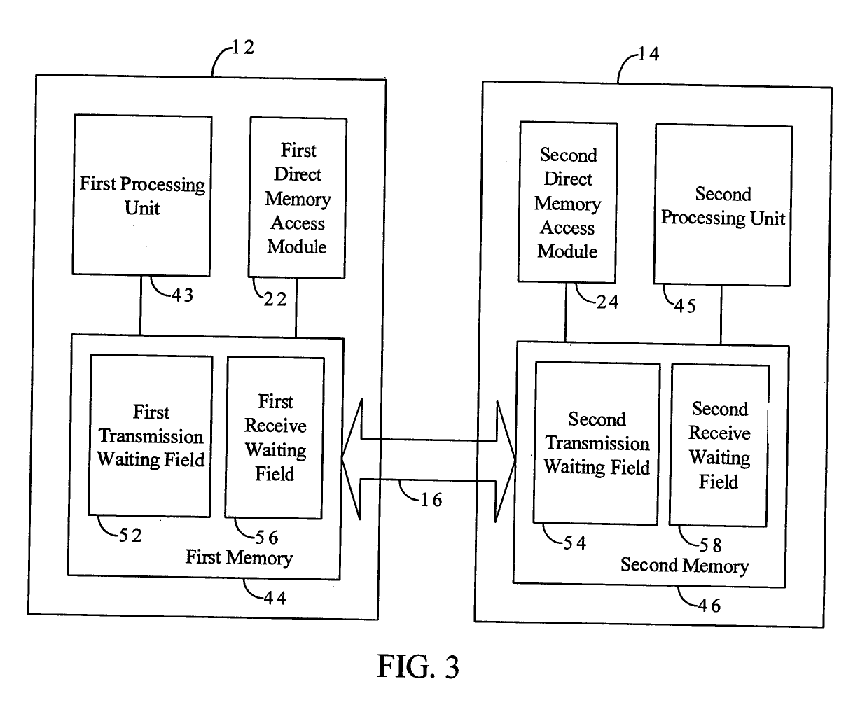

Referring to FIG. 3, FIG. 3 is a schematic diagram of the hardware system of the first micro-processor 12 and the second micro-processor 14 shown in FIG. 1. As shown in FIG. 3, the hardware system of the first micro-processor 12 comprises a first counting unit 43, a first memory 44, and the first direct memory access module 22. Correspondingly, the hardware system of the second micro-processor 14 comprises a second counting unit 45, a second memory 46, and the second direct memory access module 24. The first memory 44 comprises a first transmission waiting field 52 and a first receiving waiting field 56. The second memory 46 comprises a second transmission waiting field 54 and a second receiving waiting field 58. The above-mentioned first transmission controlling program 18 and second transmission controlling program 20 (not shown in FIG. 3) are performed in the above-mentioned hardware systems and are used for controlling the above-mentioned hardware systems.

When the first micro-processor 12 desires to transmit the first transmission data 30 to the second micro-processor 14, the first transmission controlling program 18 separates the first transmission data 30 into multiple sections of data messages and temporarily stores the messages in the first transmission waiting field 52 of the first memory 44, and then the messages are sequentially transmitted to the second receiving waiting field 58 of the second memory 46 via the serial data bus 16. The second transmission controlling program 20 determines whether the transmission is completed according to the total number of cut sections. The second transmission controlling program 20 reads the second receiving waiting field 58 and determines whether the receiving action is completed according to the header information field 32, and then it reconstructs the multiple sections of data messages to form the original first transmission data.

When the second micro-processor 14 desires to transmit a second transmission data to the first micro-processor 12, the second transmission controlling program 20 is able to transmit data to the first micro-processor 12 by the above-mentioned method. In the embedded computer system 10 of the present invention, both transmission ends are able to perform the transmission and receiving actions at the same time; the micro-processors, which transmit or receive data, are able to transmit and receive the data messages at the same time. Besides, the transmission or receiving actions are performed by the first direct memory access module 22 and the second direct memory access module 24; therefore, the data can be directly exchanged between the first memory and the second memory without passing through the first counting unit 43 or the second counting unit 45.

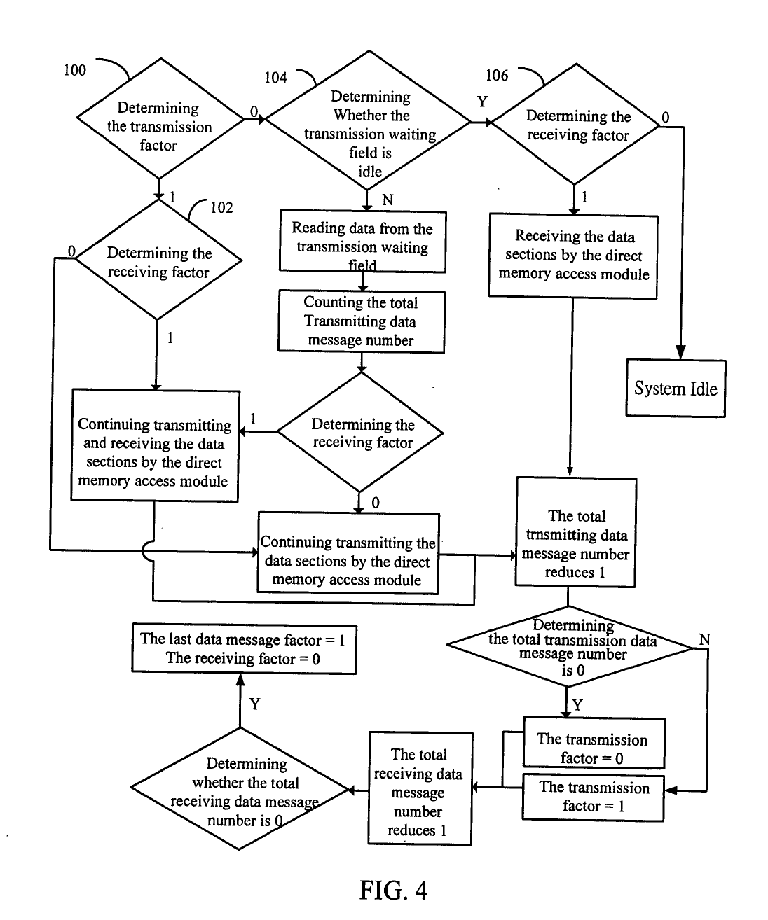

Referring to FIG. 4, FIG. 4 is a schematic diagram of the transmission pre-processing function of the embedded computer system 10. In the embedded computer system 10 of the present invention, both the first transmission controlling program 18 and the second transmission controlling program 20 use the transmission pre-processing function shown in FIG. 4 for controlling the transmission and reception of the data. First, both the first transmission controlling program 18 and the second transmission controlling program 20 comprise the following factors: the transmission factor, the receiving factor, the last data message factor, the total transmission data message number, and the total receiving data message number. The transmission factor and the receiving factor are used for respectively indicating whether the micro-processor is performing the transmission and receiving actions. The transmission controlling program performs the corresponding reaction according to the present status of the micro-processor. In one embodiment, if the transmission factor or the receiving factor is equal to 0, that means the micro-processor is not transmitting or receiving data message at the moment; on the other hand, if the receiving factor is equal to 1, that means the micro-processor is transmitting or receiving data message presently. The last data message factor is used for indicating whether the receiving action is completed. Furthermore, the total transmission data message number or the total receiving data message number is used for recording the data message numbers that have not been transmitted or received yet.

As shown in FIG. 4, the first transmission controlling program 18 and the second transmission controlling program 20 respectively operate the transmission pre-processing function of the present invention to first respectively determine the present transmission or receiving status of the controlled first micro-processor 12 and the second micro-processor 14, and they further respectively set the direct memory access modules (22 and 24) according to the transmission or receiving status and execute the transmission actions. Herein, according to the transmission or receiving status, the transmission function of the present invention may generate four determined results: the status of transmitting or receiving, the status of transmitting but not receiving, the status of receiving but not transmitting, and the status of not transmitting and not receiving. The transmission factors and the receiving factors of the above-mentioned four statuses are respectively shown as (1,1), (1,0), (0,1), and (0,0).

As shown in FIG. 4, the transmission pre-processing function of the present invention starts from step 100. In step 100, according to the transmission factor, the present invention determines whether data is being transmitted; if yes, then step 102 is performed; if no, then step 104 is performed. In step 100, if the transmission factor is equal to 0, that means the micro-processor is not transmitting data at the moment; if the transmission factor is equal to 1, that means the micro-processor is transmitting data presently. In step 102, according to the receiving factor, the present invention determines whether the data is being received; if yes, then the micro-processor continuously transmits and receives the data sections by the direct memory access; if no, then the micro-processor continuously transmits the data sections by the direct memory access. In step 102, if the receiving factor is 0, that means the micro-processor is not receiving data at the moment; if the receiving factor is equal to 1, that means the micro-processor is receiving data presently.

If the transmission factor is 0 in step 100, meaning data is not transmitted, then the present invention performs step 104 to further determine whether the transmission waiting field is idle. In step 104, if the transmission waiting field is idle, then there is no data needed to be transmitted; if the transmission waiting field is not idle, then the micro-processor reads the data of the transmission waiting field and performs the corresponding reactions. If the transmission waiting field indicated in step 104 is idle, the present invention performs step 106 to further check the receiving factors for determining whether the present invention is receiving data. If the present invention is receiving data, the present invention sets to continue receiving the data sections by the direct memory access. If the micro-processor is not receiving data, that means the system is idle.

According to the above descriptions, the transmission pre-processing function is able to determine which one of the four above-mentioned statuses the micro-processor is in. Then, the transmission pre-processing function respectively sets the the direct memory access module for transmitting and/or receiving data according to the four statuses ((1,1), (1,0), (0,1), and (0,0)). When the status is (1, 1), then the transmission pre-processing function sets the direct memory access module for transmitting and receiving data. When the status is (1,0), then the transmission pre-processing function sets the direct memory access module for transmitting data. When the status is (0,1), then the transmission pre-processing function sets the direct memory access module for receiving data. When the status is (0,0), the system is idle.

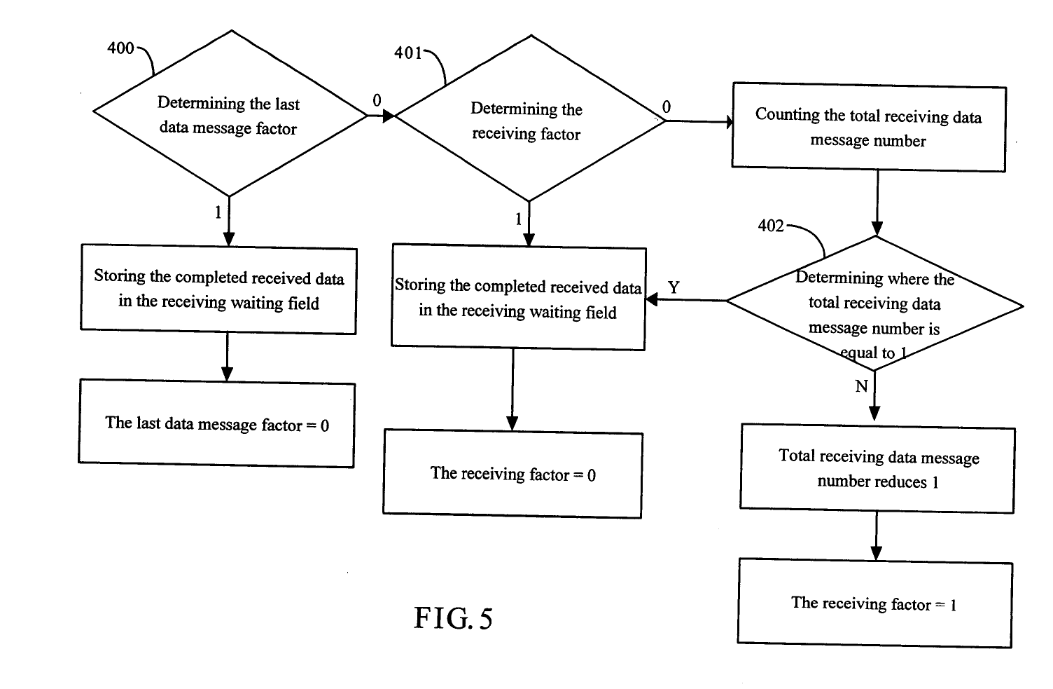

Referring to FIG. 5, FIG. 5 is a schematic diagram of the transmission post-processing function of the embedded computer system 10. In the embedded computer system 10 of the present invention, both the first transmission controlling program 18 and the second transmission controlling program 20 use the transmission pre-processing function shown in FIG. 5 for controlling the transmission and reception of data. First, both the first transmission controlling program 18 and the second transmission controlling program 20 comprise the following factors: receiving factor, last data message factor, and total receiving data message number. The receiving factor is used for indicating whether the micro-processor is performing the receiving action. The transmission controlling program performs the corresponding reaction according to the present status of the micro-processor. In one embodiment, if the receiving factor is equal to 0, that means the micro-processor is not receiving data message; on the other hand, if the receiving factor is equal to 1, that means the micro-processor is receiving data message presently. The last data message factor is used for indicating whether the receiving action is completed. Furthermore, the total receiving data message number is used for recording the data message numbers that have not been received yet.

As shown in FIG. 5, the transmission post-processing function starts from step 400. In step 400, the micro-processor determines whether data has been completely received according to the last data message factors. If no, then the micro-processor performs step 401; if yes, then the micro-processor stores the entire data in the received data waiting field. In step 401, the present invention determines whether data is being received presently according to the receiving factor; if no, then the micro-processor counts the number of sections of the data to be received, according to the header data. In step 401, if the received factor is 1, that means the micro-processor is receiving data now; if the receiving factor is 0, that means the micro-processorn is not receiving data.

As shown in FIG. 5, when the number of sections of the data to be received is counted, the micro-processor performs the step 402. In step 402, the micro-processor determines whether the data has been completely received according to the total receiving data message number. If yes, then the micro-processor stores the entire data in the received data waiting field. If no, then the micro-processor continues to receive data.

Referring to FIG. 1, FIG. 4, and FIG. 5, in the embedded computer system 10, the first transmission controlling program 18 and the second transmission controlling program 20 respectively control the transmitting and receiving actions by the transmission pre-processing function shown in FIG. 4 and the transmission post-processing function shown in FIG. 5. Therefore, the first micro-processor 12 and the second micro-processor 14 are able to exchange data by the transmitting and receiving capacities of the present invention. Besides, if the embedded computer system 10 has other micro-processors, the other micro-processors are able to transmit data during the intervals of different data sections while the first micro-processor 12 and the second micro-processor 14 exchange data, without having to wait until the first micro-processor 12 and the second micro-processor 14 has completed exchanging data.

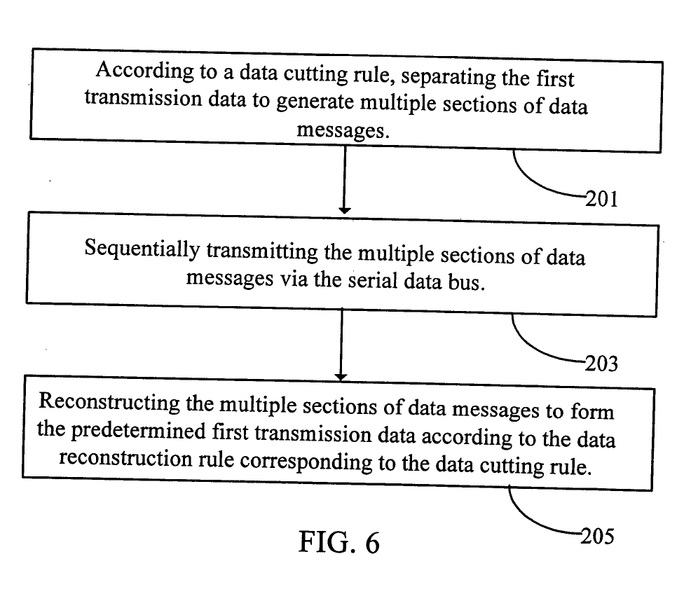

Referring to FIG. 6, FIG. 6 is a flow chart of the data transmission method of the embedded computer system of the present invention. The present invention also provides a data transmission method for the embedded computer system 10 shown in FIG. 1; the data transmission method transmits the data from the first micro-processor 12 to the second micro-processor 14 via the serial data bus 16 or transmits the data from the second micro-processor 14 to the first micro-processor 12 via the serial data bus 16. In the following paragraphs, the data transmission method of the present invention is described in the case of transmitting the first transmission data 30 from the first micro-processor 12 to the second micro-processor 14. And the needed hardware system is the same as that mentioned above. The data transmission method of the present invention also operates according to the data cutting rule and the corresponding data reconstruction rule shown in FIG. 2 and the descriptions thereof.

As shown in FIG. 6, in step 201, the present invention separates the first transmission data 30 according to the above-mentioned data cutting rule, so as to generate multiple sections of data messages (34, 36, 38, and 40). Next, in step 203, the first micro-processor 12 sequentially transmits the multiple sections of data messages (34, 36, 38, and 40) to the second micro-processor 14 via the serial data bus 16. Then, in step 205, the second micro-processor reconstructs the multiple sections of data messages (34, 36, 38, and 40) to form the first transmission data 30 according to the data reconstruction rule corresponded to the data cutting rule.

The data cutting rule described in step 201 is the data cutting rule described in FIG. 2 and the description thereof; the lengths of each cut section of data messages (34, 36, 38, and 40) are all the same, wherein the head data message 34 comprises the header information field 32, and the other three data messages (36, 38, and 40) are respectively three data fields. The header information field 32 records the data length and the data type of the first transmission data 30; therefore, the header information field 32 comprises the first data length of the first transmission data.

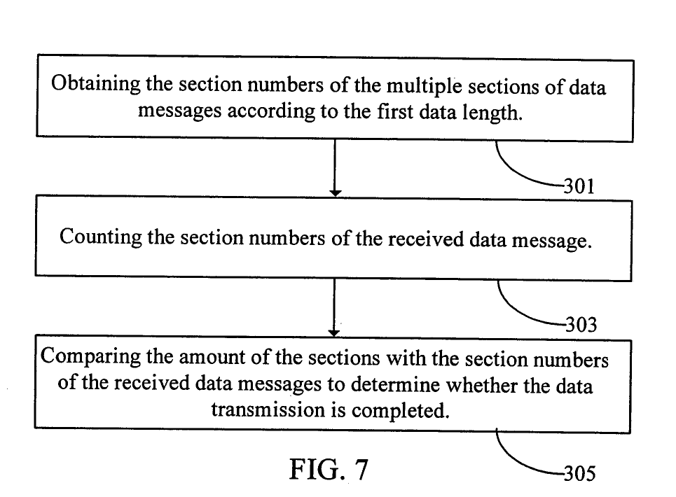

Referring to FIG. 7, FIG. 7 is a detailed flow chart of step 205 of the data transmission method shown in FIG. 6, which determines whether the transmission is completed. As mentioned above, the data transmission method of the present invention comprises the transmitting and receiving actions. When the second micro-processor 14 receives the data, the data transmission method further performs the following steps for determining whether the data receiving action is completed. In step 301, the number of sections of the data messages, which are transmitted, are obtained according to the first data length. Because each data section has the same length, the number of sections of the data messages is counted according to the first data length; this number is the number of sections of messages to be received. Next, in step 303, the number of sections of the received data messages is counted. In step 305, the present invention compares the number of sections of data messages to be received with the number of sections of the received data messages, so as to determine whether transmission is completed.

Comparing to the prior arts, the embedded computer system of the present invention separates each transmission data into multiple sections of data messages according to the predetermined data cutting rule by the transmission controlling program, then it receives the multiple sections of data messages and reconstructs the received multiple sections of data messages to form the original transmission data. Therefore, when each micro-processor of the embedded computer system of the present invention is able to exchange data via the serial data bus, the correctness of the data is still being maintained. Besides, by separateting the transmission data into multiple sections of data messages, during the intervals between the transmissions of different sections of data messages, the serial data bus is idle, and different micro-processors are able to transmit data via the serial data bus, so that the waiting time can be reduced.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

1. An embedded computer system comprising:
a first micro-processor comprising a first transmission controlling program;
a second micro-processor comprising a second transmission controlling program; and
a serial data bus enabling the first micro-processor to transmit a first transmission data to the second micro-processor;
wherein, the first transmission controlling program of the first micro-processor separates the first transmission data into multiple sections of data messages according to a predetermined data cutting rule, and then the data messages are sequentially transmitted to the second micro-processor via the serial data bus, and wherein the second transmission controlling program of the second micro-processor reconstructs the received data messages to form the first transmission data according to a corresponding data reconstruction rule.

2. The embedded computer system of claim 1, wherein the data cutting rule is to separate the first transmission data into multiple sections of data messages of equal length, and the multiple sections of equal-length data messages comprise a header information field and multiple data fields.

3. The embedded computer system of claim 2, wherein the header information field records a data length information and a data type information of the first transmission data.

4. The embedded computer system of claim 3, wherein the data reconstruction rule is to sequentially remove the header information fields of the multiple sections of equal-length data messages, and to sequentially reconstruct the multiple data fields to form the first transmission data.

5. The embedded computer system of claim 1, wherein the first micro-processor further comprises a first direct memory access module.

6. The embedded computer system of claim 5, wherein the first micro-processor transmits the multiple sections of data messages to the second micro-processor by the first direct memory access module.

7. The embedded computer system of claim 1, wherein the second transmission controlling program of the second micro-processor is capable of separating another second transmission data into multiple sections of data messages according to the predetermined data cutting rule, and then the data messages are transmitted to the first micro-processor via the serial data bus, and wherein the first transmission controlling program of the first micro-processor then reconstructs the received data messages to form the second transmission data according to the corresponding data reconstruction rule.

8. The embedded computer system of claim 7, wherein the second micro-processor further comprises a second direct memory access module.

9. The embedded computer system of claim 8, wherein the second micro-processor transmits the multiple sections of data messages to the first micro-processor by the second direct memory access module.

10. The embedded computer system of claim 1, wherein the computer system is a non-PC embedded computer system.

11. A data transmission method for an embedded computer system, the embedded computer system comprising a first micro-processor, a second micro-processor, and a serial data bus, the data transmission method transmitting a first transmission data from the first micro-processor to the second micro-processor via the serial data bus, the data transmission method comprising the following steps:
(1) according to a data cutting rule, separating the first transmission data to generate multiple sections of data messages;
(2) the first micro-processor sequentially transmitting the multiple sections of data messages to the second micro-processor via the serial data bus; and
(3) the second micro-processor reconstructing the multiple sections of data messages to form the first transmission data according to a corresponding data reconstruction rule.

12. The data transmission method of claim 11, wherein step (1) is to separate the first transmission data into multiple sections of data messages of equal length, and the multiple sections of equal-length data messages comprise a header information field and multiple data fields.

13. The data transmission method of claim 12, wherein the header information field comprises a first data type and a first data length of the first transmission data.

14. The data transmission method of claim 13, wherein the step (3) further comprises the following steps:
(3-1) obtaining the number of sections of the multiple sections of data messages according to the first data length;
(3-2) counting the number of sections of the received data messages; and
(3-3) comparing the number of sections in (3-1) with the number of sections of the received data messages to determine whether the data transmission is completed.
